(19) United States
(12) Patent Application Publication
(10) Pub. No.: US 2024/0052633 A1
(43) Pub. Date: Feb. 15, 2024

(54) MINERAL FIBRE BOARD

(71) Applicants: Knauf Insulation SPRL, Vise (BE); Knauf Insulation, Inc., Shelbyville, IN (US)

(72) Inventors: Roger Jackson, Stl Helens (GB); Tony Aindow, St. Helens (GB); George Baybutt, St. Helens (GB)

(21) Appl. No.: 18/383,443

(22) Filed: Oct. 24, 2023

Related U.S. Application Data
(63) Continuation of application No. 18/233,325, filed on Aug. 13, 2023.
Application No. 18/233,325 is a continuation of application No. 18/200,217, filed on May 22, 2023.
Application No. 18/200,217 is a continuation of application No. 18/121,457, filed on Mar. 14, 2023, now abandoned.
Application No. 18/121,457 is a continuation of application No. 18/070,372, filed on Nov. 28, 2022, now abandoned.
Application No. 18/070,372 is a continuation of application No. 17/902,839, filed on Sep. 4, 2022, now abandoned.
Application No. 17/902,839 is a continuation of application No. 17/006,735, filed on Aug. 28, 2020, now Pat. No. 11,459,754.
Application No. 17/006,735 is a continuation of application No. 16/904,535, filed on Jun. 17, 2020, now abandoned.
Application No. 16/904,535 is a continuation of application No. 16/844,998, filed on Apr. 9, 2020, now abandoned.
Application No. 16/844,998 is a continuation of application No. 15/690,623, filed on Aug. 30, 2017, now Pat. No. 10,968,629.
Application No. 15/690,623 is a continuation of application No. 12/524,512, filed on Nov. 12, 2009, now abandoned.

(51) Int. Cl. E04C 2/16; D06M 13/207; D06M 13/463; E04B 1/80; C03C 25/321

(52) U.S. Cl. CPC E04C 2/16; D06M 13/207; D06M 13/463; E04B 1/80; C03C 25/321; D10B 2401/063; Y10T 428/24; D06M 2200/30; D10B 2101/02; D10B 2403/0243; D10B 2505/20; D06M 2101/40

(57) ABSTRACT

A high density mineral fibre board having a formaldehyde free binder has acceptable strength and good dimensional stability.

### CROSS-REFERENCE TO RELATED APPLICATIONS

This application is a continuation of U.S. application Ser. No. 12/524,512, filed Jul. 24, 2009, which is a U.S. national counterpart application of international application serial no. PCT/EP2007/050749, filed Jan. 25, 2007.

### FIELD OF THE INVENTION

This invention relates to a mineral fibre insulating product having a low formaldehyde or formaldehyde free binder.

### BACKGROUND

Industry standard binders used for fibre insulation, for example glass wool and rock wool insulation are based on phenol formaldehyde. Whilst such binders can provide suitable properties to the insulating products there has for some time been a desire to move away from the use of phenol formaldehyde, particularly due to environmental considerations.

Traditional polyester based binder systems have previously been proposed but have not gained acceptance in the insulation industry, particularly as their strength in holding the mineral fibres together, especially when exposed to moisture or weathering, has been perceived as insufficient.

To date, only one low formaldehyde based mineral insulation binder system has been used on an industrial scale on glass wool insulation; this is based on polyacrylic acid and supplied by Rohm&Haas. Unfortunately, the highly acid nature of these types of binders can cause excessive corrosion of manufacturing plant unless significant investment is made in acid resistant equipment. U.S. Pat. No. 5,977,232 discloses a formaldehyde free binder for glass wool insulation based on a polycarboxylic acid. European patent application EP1698598A discloses use of a corrosion meter to try to mitigate problems associated with polycarboxylic acid-based fibreglass binder resins. In addition, whilst the strength of these binders is acceptable for some applications it is not as good as the commonly used phenol formaldehyde based binders.

It has not been thought possible to provide a formaldehyde free binder system useable on an industrial scale that will confer characteristics to mineral wool insulating products that could match or even exceed those obtained with formaldehyde binders.

### SUMMARY

According to one aspect, the present invention provides a mineral fibre insulating board as defined in claim 1. Other aspects are defined in other independent claims. Preferred and/or alternative features are defined in the dependent claims.

### DETAILED DESCRIPTION

As used herein, the term formaldehyde free means that the composition is substantially free from formaldehyde, preferably does not liberate substantial formaldehyde as a result of drying or curing and/or preferably comprises less than one part per million by weight of formaldehyde.

Desired characteristics of the mineral fibre insulation board can be assessed by measuring Ordinary Compression Strength and/or Weathered Compression Strength and/or change in thickness after autoclave.

The invention may be particularly useful in applications where dimensional stability of the insulation board is important. It is surprising that a formaldehyde free binder can confer the strength and/or dimensional stability that has been found.

The insulating board may be: a fire barrier; a fire protection; cladding for a building; a ceiling tile; a roof board; thermal insulation for high temperature machinery for example, generators, ovens and industrial plant; foundation wall insulation, for example for use in basements or in a wall or partition between a room and a layer of earth and/or rock. The insulating board may be used to provide thermal and/or acoustic insulation.

The cured binder content may be in the range 0.5%-15% by weight determined for example by loss on ignition. A cured binder content of 0.5-5% by weight, particularly 1.5-3.5% by weight may provide suitable characteristics, particularly with respect to one or more of the products mentioned above.

The binder may:
be based on a reducing sugar; and/or
be based on reductosis; and/or
be based on an aldehyde containing sugars/and/or
include at least one reaction product of a carbohydrate reactant and an amine reactant; and/or
include at least one reaction product of a reducing sugar and an amine reactant; and/or
include at least one reaction product of a carbohydrate reactant and a polycarboxylic acid ammonium salt reactant; and/or
include at least one reaction product from a Maillard reaction.

The binder may be based on a combination of a polycarboxylic acid, for example citric acid, a sugar, for example dextrose, and a source of ammonia, for example ammonia solution. It may be based on a combination of ammonium citrate and dextrose. Where the binder is based on sugars and/or citric acid and/or comprises significant —OH groups, it is particularly surprising that such levels of performance can be achieved. It would have been thought that the —OH groups for example in the sugars and/or citric acid would be readily subject to hydrolysis and that this would be detrimental to strength, particularly weathered strength, and/or dimensional stability.

The binder may comprise a silicon containing compound, particularly a silane; this may be an amino-substituted compound; it may be a silyl ether; it may facilitate adherence of the binder to the mineral fibres.

The binder may comprise melanoidins; it may be a thermoset binder; it may be thermally curable.

The binder may be one of those disclosed in International patent application no PCT/US2006/028929, the contents of which is hereby incorporated by reference.

The insulating board may have
a nominal thickness in the range 20 to 200 mm; and/or
a thermal resistance R of R≥1.7 m²K/W, preferably R≥2 m²K/W at a thickness or 100 mm; and/or
a density in the range 100 to 200 kg/m³, particularly 130 to 190 kg/m³.

The density may be in the order of 110 kg/m³, for example in the range 100 to 120 kg/m³; it may be in the order of 140 kg/m³, for example in the range 130 to 150 kg/m³; in the order of 180 kg/m³, for example in the range 170 to 190 kg/m³. Such density can provide products with desirable characteristics.

The mineral fibres may be glass wool or rock wool; the fibres may have an average diameter between 2 and 9 microns or be microfibres of smaller diameter; they may have an average length between 8 and 80 mm.

The mineral fibres may be crimped.

The insulating board preferably has good stability in a High Temperature Shrinkage test. The performance in such a test generally depends upon the thickness and density of the board. Table 1 shows desired performance for a 80 mm thick board with a density of 150 kg/m³. The low level of High Density Shrinkage is particularly surprising as it was assumed that shrinkage is primarily determined by fibre composition and little influenced by the binder.

### EXAMPLE

A non-limiting example of the invention is described below.

An aqueous binder was prepared by mixing together:

| | Approximate |
|---|---|
| | % by weight |
| Powdered dextrose monohydrate | 19.1% |
| Powdered anhydrous citric acid | 3.4% |
| 28% aqueous ammonia | 2.6% |
| Silane A-1100 | 0.07% |
| Water | 73.5% |

This binder was used in the manufacture of a rock wool roof board on a standard manufacturing line, the binder being sprayed onto the fibres just after fiberising and the coated fibres being collected, assembled in to a mat, compressed and cured in the usual way.

The cured roof board had:
a binder content of about 3% by weight as determined by loss on ignition
a thickness of about 80 mm
a density of about 150 kg/m³

Desired characteristics and results achieved are set out in Table 1:

TABLE 1

| | | | | | | | Equivalent |
|---|---|---|---|---|---|---|---|
| | | | | | | | phenol |
| | | Acceptance | | More | Most | Result | formaldehyde |
| | Units | limit | Preferred | Preferred | preferred | achieved | product |
| Ordinary | kPa | ≥60 | ≥70 | ≥80 | ≥90 | 72.3 | 86.5 |
| Compression | | | | | | | |
| Strength | | | | | | | |
| Weathered | kPa | ≥25 | ≥30 | ≥40 | ≥50 | 54.6 | 32.5 |
| Compression | | | | | | | |
| Strength | | | | | | | |
| Change in | % | ≤6 | ≤5 | ≤2 | ≤0.5 | 0.2 | 4.4 |
| thickness | | | | | | | |
| after | | | | | | | |
| autoclave | | | | | | | |
| High Density | % | ≤60 | ≤50 | ≤40 | ≤30 | 21.1 | 44.9 |
| Shrinkage | | | | | | | |
| (80 mm | | | | | | | |
| thick) | | | | | | | |

The comparison in the table with a product that is equivalent other than containing a phenol formaldehyde binder shows that, surprisingly, the invention can provide improved dimensional stability, i.e. less change in thickness after autoclave and improved High Density Shrinkage.

### Testing of Ordinary Compression Strength and Weathered Compression Strength:

Ordinary Compression Strength is determined according to British Standard BS EN 826: 1996 (incorporated herein by reference).

Weathered Compression Strength is determined according to British Standard BS EN 826: 1996 on samples that have been subjected to the following accelerated weathering procedure: samples are cut to size and then placed in a preheated autoclave and conditioned on a wire mesh shelf away from the bottom of the chamber under wet steam at 35kN/m² for one hour. They are then removed, dried in an oven at 100° C. for five minutes and tested immediately for compression strength.

In both cases, compression strength is determined in the direction of the thickness of the product; the dimensions of face of the samples in contact with the compression test apparatus are preferably 200 mm×200 mm.

### Testing of Change in Thickness After Autoclave:

The thickness of the samples is determined, for example in accordance with British Standard BS EN 823: 1995 and recorded. The samples are then placed in a preheated autoclave and conditioned on a wire mesh shelf away from the bottom of the chamber under wet steam at 35kN/m² for one hour. They are then removed, dried in an oven at 100° C. for five minutes and their thickness is immediately measured again. The change in thickness after autoclave is calculated as (((thickness after autoclave)−(thickness before autoclave))/(thickness before autoclave))×100.

### Testing of High Density Shrinkage:

Four samples 100 mm×75 mm are cut at random from an insulating board to be tested using a band saw or equivalent to ensure square and straight edges. The width and length at the centre position of the top and bottom face is measured, for example using a metal rule in mm. The mean average length Il and mean average width wl is calculated from these measurements for each sample. For each sample, the thickness at the centre position of each edge of the sample is measured and the mean average thickness tl calculated from these measurements.

Each sample is placed individually in the centre of a muffle furnace maintained at a temperature of 800° C. The sample is removed from the furnace after 30 minutes and allowed to cool to room temperature on a wire tray. When cool, the width, length and thickness of the sample is measured in the same way as before and the mean average width w2, length I2and thickness t2 calculated in the same way.

The shrinkage for the sample is calculated using the formula:

Shrinkage=(((ll×wl×tl)−(I2×w2×t2))/(ll×wl×tl))×100

The High Density Shrinkage is calculated as the mean average of the % shrinkage of the four samples.

1.-12. (canceled)

13. A mineral fiber insulating board having a density in a range from about 100 to about 200 kg/m³ comprising mineral fibers and an organic, formaldehyde free binder,
wherein the mineral fiber insulating board has:
a) an ordinary compression strength of at least about 60 kPa; and
b) a weathered compression strength of at least about 25 kPa; and
c) a change in thickness of less than about 6% after autoclave.

14. The mineral fiber insulating board of claim 13, wherein the ordinary compression strength is at least about 70 kPa.

15. The mineral fiber insulating board of claim 13, wherein the weathered compression strength is at least about 30 kPa.

16. The mineral fiber insulating board of claim 13, wherein the change in thickness after autoclave is less than about 5%.

17. The mineral fiber insulating board of claim 13, wherein the fibers are rock wool mineral fibers.

18. The mineral fiber insulating board of claim 13, wherein the mineral fiber insulating board comprises from about 0. 5% to about 5% of organic, formaldehyde free binder by weight.

19. The mineral fiber insulating board of claim 13, wherein the organic, formaldehyde free binder comprises a product of a reaction including a reducing sugar.

20. The mineral fiber insulating board of claim 13, wherein the organic, formaldehyde free binder comprises at least one Maillard reaction product.

21. The mineral fiber insulating board of claim 13, wherein the organic, formaldehyde fee binder comprises a product of curing an aqueous solution comprising citric acid, ammonia and dextrose.

22. The mineral fiber insulating board of claim 13, wherein the density is from about 130 to about 190 kg/m³.

23. The mineral fiber insulating board of claim 13, wherein the mineral fiber insulating board is adapted for a use selected from a group consisting of a fire barrier, fire protection, cladding for buildings, ceiling tiles, a roof board, thermal insulation for high temperature machinery, and foundation walls for basements.

24. A method of manufacturing a mineral fiber insulating board comprising
applying an aqueous binder solution to a plurality of mineral fibers, dehydrating the aqueous binder solution such that a substantially dehydrated binder is disposed on the plurality of mineral fibers and curing the substantially dehydrated binder, wherein
a) the mineral fiber insulating board has a density from about 100 to about 200 kg/m³,
b) the mineral fiber insulating board has an ordinary compression strength of at least about 60 kPa,
c) the mineral fiber insulating board has a weathered compression strength of at least about 25 kPa, and
d) the mineral fiber insulating board a change in thickness of less than 6% after autoclave, and
e) the aqueous binder solution is formaldehyde free.
